(19) United States
(12) Patent Application Publication
(10) Pub. No.: US 2006/0195701 A1
(43) Pub. Date: Aug. 31, 2006

(54) In-process protection for digital content communication systems

(75) Inventors: Donald Dew, Ajax (CA); M. Michael Serbinis, Toronto (CA); Robert Zuber, San Francisco, CA (US)

Correspondence Address: THELEN REID & PRIEST, LLP, P. O. BOX 640640, SAN JOSE, CA, 95164-0640, US

(73) Assignee: Critical Path, Inc., a California Corporation

(21) Appl. No.: 11/354,296

(22) Filed: Feb. 13, 2006

Related U.S. Application Data
(60) Provisional application No. 60/652,261, filed on Feb. 11, 2005.

(51) Int. Cl. H04L 9/32

(52) U.S. Cl. 713/188

(57) ABSTRACT

A method and system for providing in-process protection for digital content is disclosed. For one embodiment of the invention, a request is received from a user to communicate digital content. The digital content is accessed and subjected to ant-abuse analysis. A portion of the digital content, determined based upon the anti-abuse analysis, is then communicated in accordance with the request. For one embodiment of the invention the anti-abuse analysis includes spam filtering and virus detection.

### CROSS-REFERENCE TO RELATED APPLICATION

This application is a non-provisional application claiming priority to provisional application Ser. No. 60/652,261, filed on Feb. 11, 2005, entitled “Message Router and Platform for Routing E-mail Between External E-mail Systems and Simple Hand-held Devices,” which is herein incorporated by reference in its entirety.

### FIELD OF THE INVENTION

Embodiments of the invention relate generally to the field of digital communication systems and more specifically to providing in-process protection to communicated digital content.

### BACKGROUND OF THE INVENTION

Conventional digital content communication systems allow a user to designate a source of stored digital content and have the stored digital content communicated to another location as directed by the user. For example, typical mobile messaging systems allow a user to receive digital content on a mobile communications device (mobile device) from external sources of stored digital content. The digital content may include e-mail, news feeds (e.g., RSS news feeds), blogs, audio and video clips and multimedia for example, while mobile devices may include hand-held devices such as personal digital assistants (PDAs) and cellular phones or wireless devices having messaging functionality.

Such systems often allow the user to have digital content that is addressed to one or more destinations forwarded to the mobile device. For example, a user may maintain several e-mail accounts and have the e-mail messages that get delivered to all of those accounts subsequently delivered to the mobile device.

A user may wish to have many of the e-mail messages received through various accounts forwarded to the mobile device, but for a number of reasons may wish that some or even most of the e-mails were not forwarded. For example, typical messaging service providers charge the user based upon the amount of digital content that is forwarded to the mobile device. Having all digital content forwarded to the mobile device may therefore be cost prohibitive and the user may wish to have only that digital content deemed sufficiently important forwarded to the mobile device.

For this reason many conventional digital content communication systems provide digital content anti-abuse programs (e.g., digital content filtering programs and virus detection programs) to prevent forwarding digital content that is determined to be spam or digital content containing a virus (e.g., any undesired code) to a mobile device.

Such filtering programs generally identify most spam and viruses, however the filtering is accomplished at the source when the digital content is received and stored. Digital content determined to be spam or contain a virus may be stored separately or not stored.

Typically, digital content communications systems that forward stored digital content assume that the content has been filtered for spam and viruses. However, some digital content storage locations do not provide filtering and many often provide inadequate filtering.

This may result in undesired digital content or virus-bearing digital content being forwarded to a user due to the methods used to determine that digital content is spam and the nature of viruses.

Digital content may be determined to be spam in a number of ways and whether or not particular digital content is spam is based upon the subjective opinion of the recipient. Generally, spam is any unsolicited, non-consensual, electronic communication, typically of a commercial nature, and usually transmitted in bulk to many recipients. Spam includes unsolicited commercial e-mail (UCE), unsolicited bulk e-mail (UBE), gray mail, and just plain “junk mail,” and is typically used to advertise products.

Spam detection schemes may involve application of a rules-based filtering system or the use of statistical classifiers that determine digital content is spam based upon an analysis of words that occur frequently in digital content previously determined to be spam.

This means that digital content that is spam may not meet the definition of spam currently employed by the particular digital content filtering scheme at the time it is stored to a external storage device.

This situation can be quite problematic, especially for users of mobile devices. The user typically has to pay for the communication of unwanted digital content. Moreover, many mobile devices can present only a relatively limited amount of digital content to the user at a time. This means the user may spend quite a bit of time addressing the unwanted digital content.

### SUMMARY OF THE INVENTION

In accordance with one embodiment of the invention a request is received from a user to communicate digital content. The digital content is accessed and subjected to anti-abuse analysis. A portion of the digital content, determined based upon the anti-abuse analysis, is then communicated in accordance with the request. For one embodiment of the invention the anti-abuse analysis includes spam filtering and virus detection.

Other features and advantages of embodiments of the present invention will be apparent from the accompanying drawings, and from the detailed description, that follows below.

### BRIEF DESCRIPTION OF THE DRAWINGS

The invention may be best understood by referring to the following description and accompanying drawings that are used to illustrate embodiments of the invention. In the drawings:

FIG. 1 illustrates a system in which digital content may communicated and provide with in-process protection in accordance with one embodiment of the invention;

FIG. 2 illustrates a process in which anti-abuse protection is applied to digital content during the communication process in accordance with one embodiment of the invention; and

FIG. 3 illustrates a functional block diagram of a digital processing system in accordance with one embodiment of the invention.

### DETAILED DESCRIPTION

A method and system for providing in-process protection for digital content is disclosed. For one embodiment of the invention, a request is received from a user to communicate digital content. The digital content is accessed and subjected to ant-abuse analysis. A portion of the digital content, determined based upon the anti-abuse analysis, is then communicated in accordance with the request. For one embodiment of the invention the anti-abuse analysis includes spam filtering and virus detection.

In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

Embodiments of the invention are applicable in a variety of settings in which digital content is communicated and in-process protection of such content may be desired.

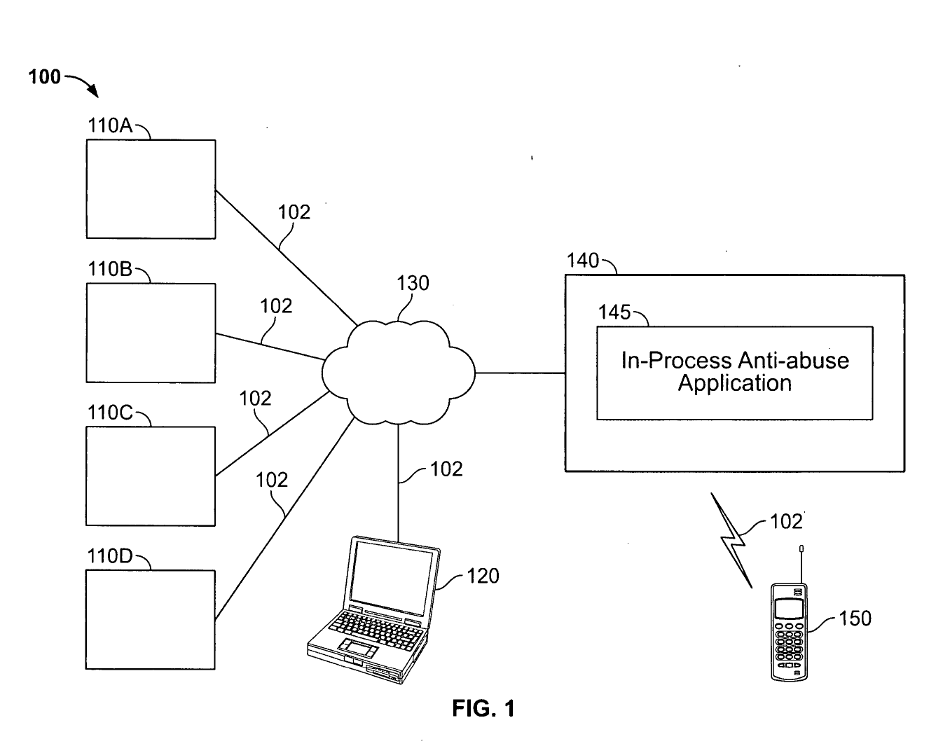

FIG. 1 illustrates a system in which digital content may communicated and provide with in-process protection in accordance with one embodiment of the invention. System 100, shown in FIG. 1, includes a number of digital content storage devices, shown for example as digital processing systems (DPSs) 110A-110D. The DPSs 110A-110D may be network servers, personal computers, or other types of digital processing systems. The DPSs 110A-110D are configured to store and communicate a plurality of various types of digital content such as e-mails, news feeds, blogs, audio and video clips and multimedia, for example, as well as documents such as web pages, content stored on web pages, including text, graphics, and audio and video content. For example, the stored content may be audio/video files, such as programs with moving images and sound. The DPSs 110A-110D store digital content for a user which may have been communicated from any of a variety of sources, shown for example, as DPS 120.

The stored digital content may be communicated between the DPSs through any type of communications network through which a plurality of different devices may communicate such as, for example, but not limited to, the Internet, a wide area network (WAN) not shown, a local area network (LAN), an intranet, or the like. For example, as shown in FIG. 1, the DPSs are interconnected one to another through Internet 130 which is a network of networks having a method of communicating that is well known to those skilled in the art.

The user may request via the user's mobile device 150 to have some portion of the digital content stored on DPSs 110A-110D communicated as desired by the user. The mobile service provider's operator network 140 is connected via Internet 130 to the DPSs 110A-110D storing the digital content. The digital content may, in general, be untrusted digital content. For example, the operator network 140 has not determined that the digital content does not constitutes spam or contain a virus. Operator network 140, which also has digital processing capabilities, has, in accordance with one embodiment of the invention, an in-process anti-abuse application 145 installed thereon. Application 145 provides anti-abuse analysis of the digital content, which may include, for one embodiment, spam filtering and virus detection functionality.

The user's mobile device 150, which also has digital processing capability, is connected to the operator network 140. The communication links 102 coupling the DPSs, the operator network, and the mobile device need not be direct links, but may be indirect links, including but not limited to, broadcasted wireless signals, network communications or the like.

In accordance with one embodiment of the invention the application 145 accesses digital content stored on DPSs 110A-110D in accordance with a request from a user to communicate the stored digital content. The application 145 subjects the accessed digital content to anti-abuse analysis. Then, the application 145 communicates a portion of the digital content, based upon the anti-abuse analysis, in accordance with the user's request. The application 145 determines which, of the requested digital content is communicated. In accordance with one embodiment of the invention, the application 145 analyzes the digital content and formulates rules based upon the analysis. Additionally, or alternatively, rules may be formulated based upon the previous behaviors of the user and relationships between new digital content and previously accepted or denied content.

The formulated rules are then presented to the user, and if accepted by the user are applied to the digital content. In accordance with one such embodiment of the invention the formulated rules are presented to the user and accepted by the user via the mobile device 150.

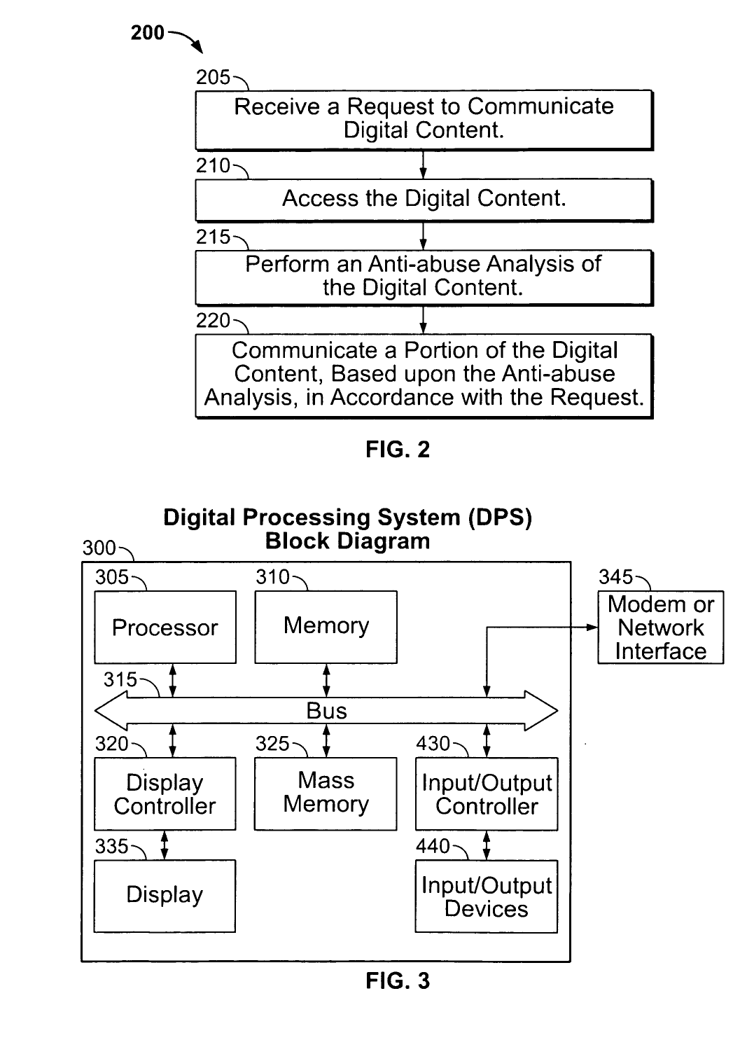

FIG. 2 illustrates a process in which anti-abuse protection is applied to digital content during the communication process in accordance with one embodiment of the invention.

Process 200, shown in FIG. 2, begins at operation 205 in which a request is received from a user to communicate digital content. Such digital content, could be, for example, stored digital content. The digital content may have been subjected to anti-abuse protections such as spam filtering and virus detection previously (e.g., when received at the storage location).

At operation 210 the digital content as directed by the user's request is accessed. For example, for one embodiment of the invention, the request may be a message requesting that e-mail messages from a particular e-mail account be forwarded to the mobile device of the user. The request message may include information to allow access to the e-mail account. Methods for configuring digital content communication systems to communicate digital content with limited configuration information from the user are discussed in copending application entitled “Configuration of Digital Content Communication Systems”.

At operation 215 an anti-abuse analysis is performed on the digital content. For example, during processing for communication, the digital content is subjected to anti-abuse analysis which may include spam filtering and virus detection. The anti-abuse analysis is performed on the digital content to determine if the digital content should be communicated. For example, the analysis may determine that the digital content contains a virus, and the digital content may, for that reason, not be communicated. Or, the analysis may determine that the digital content has a high likelihood of being spam and the digital content may, therefore, not be communicated (or may be notwithstanding based upon other concerns and directions from the user).

At operation 220 a portion of the digital content, based upon the anti-abuse analysis, is communicated as directed by the user's request. The portion communicated may range from all of the digital content (e.g., where no spam or virus was detected) to none of the digital content where, for example, all of the digital content was determined to be virus-bearing.

For example, the user may request all e-mail messages from several external e-mail accounts be forwarded to the user's mobile device. If the in-process anti-abuse application determines that a portion of the e-mail messages constitute spam, those e-mail messages will not be forwarded. Or for example, the user may request digital content from a web-site be communicated to the user's personal computer. If the in-process anti-abuse application determines that the requested digital content contains a virus, that digital content will not be communicated.

As discussed above, embodiments of the invention may employ DPSs or devices having digital processing capabilities. FIG. 3 illustrates a functional block diagram of a digital processing system that may be used in accordance with one embodiment of the invention. The components of processing system 300, shown in FIG. 3 are exemplary in which one or more components may be omitted or added. For example, one or more memory devices may be utilized for processing system 300. Referring to FIG. 3, the processing system 300, shown in FIG. 3, may be used as a server processing system. Furthermore, the processing system 300 may be used to perform one or more functions of an Internet service provider. The processing system 300 may be interfaced to external systems through a network interface or modem 345. The network interface or modem may be considered a part of the processing system 300. The network interface or modem may be an analog modem, an ISDN modem, a cable modem, a token ring interface, a satellite transmission interface, a wireless interface, or other interface(s) for providing a data communication link between two or more processing systems. The processing system 300 includes a processor 305, which may represent one or more processors and may include one or more conventional types of processors, such as Motorola PowerPC processor or Intel Pentium processor, etc. A memory 310 is coupled to the processor 305 by a bus 315. The memory 310 may be a dynamic random access memory (DRAM) an/or may include static RAM (SRAM). The processor 305 may also be coupled to other types of storage areas/memories (e.g. cache, Flash memory, disk, etc.), that could be considered as part of the memory 310 or separate from the memory 310.

The bus 315 further couples the processor 305 to a display controller 320, a mass memory 325 (e.g. a hard disk or other storage which stores all or part of the application 145, or stored digital content, depending on the DPS). The network interface or modem 345, and an input/output (I/O) controller 330. The mass memory 325 may represent a magnetic, optical, magneto-optical, tape, and/or other type of machine-readable medium/device for storing information. For example, the mass memory 325 may represent a hard disk, a read-only or writeable optical CD, etc. The display controller 320 controls, in a conventional manner, a display 335, which may represent a cathode ray tube (CRT) display, a liquid crystal display (LCD), a plasma display, or other type of display device. The I/O controller 330 controls I/O device(s) 340, which may include one or more keyboards, mouse/track ball or other pointing devices, magnetic and/or optical disk drives, printers, scanners, digital cameras, microphones, etc.

The processing system 300 represents only one example of a system, which may have many different configurations and architectures and which may be employed with the present invention. For example, various manufacturers provide systems having multiple busses, such as a peripheral bus, a dedicated cache bus, etc. On the other hand, a network computer, which may be used as a processing system of the present invention, may not include, for example, a hard disk or other mass storage device, but may receive routines and/or data from a network connection, such as the network interface or modem 345, to be processed by the processor 305. Similarly, a portable communication and data processing system, which may employ a cellular telephone and/or paging capabilities, may be considered a processing system that may be used with the present invention. However, such a system may not include one or more I/O devices, such as those described above with reference to I/O device 340.

In the system 300 shown in FIG. 3, the mass memory 325 (and/or the memory 310) may store data that may be processed according to the present invention. For example, the mass memory 325 may contain a database storing previously determined configuration information in accordance with one embodiment of the invention. Alternatively, data may be received by the processing system 300, for example, via the network interface or modem 345, and stored and/or presented by the display 335 and/or the I/O device(s) 340. In one embodiment, data may be transmitted across a data communication network, such as a LAN and/or the Internet.

General Matters

Embodiments of the invention include a system that provides in-process protection for digital content. For one embodiment of the invention, a request is received from a user to communicate digital content. The digital content is accessed and subjected to ant-abuse analysis. A portion of the digital content, determined based upon the anti-abuse analysis, is then communicated in accordance with the request. For one embodiment of the invention the anti-abuse analysis includes spam filtering and virus detection.

Embodiments of the invention have been described as including various operations. Many of the processes are described in their most basic form, but operations can be added to or deleted from any of the processes without departing from the scope of the invention.

The operations of the invention may be performed by hardware components or may be embodied in machine-executable instructions, which may be used to cause a general-purpose or special-purpose processor or logic circuits programmed with the instructions to perform the operations. Alternatively, the steps may be performed by a combination of hardware and software. The invention may be provided as a computer program product that may include a machine-readable medium having stored thereon instructions, which may be used to program a computer (or other electronic devices) to perform a process according to the invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media / machine-readable medium suitable for storing electronic instructions. Moreover, the invention may also be downloaded as a computer program product, wherein the program may be transferred from a remote computer to a requesting computer by way of data signals embodied in a carrier wave or other propagation medium via a communication cell (e.g., a modem or network connection). All operations may be performed at the same central cite or, alternatively, one or more operations may be performed elsewhere.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
receiving a request from a user to communicate digital content;
accessing the digital content;
performing anti-abuse analysis of the digital content; and
communicating a portion of the digital content, based upon the anti-abuse analysis, in accordance with the request.

2. The method of claim 1 wherein the anti-abuse analysis determines if the digital constitutes spam.

3. The method of claim 1 wherein the anti-abuse analysis determines if the digital contains a virus.

4. The method of claim 1, wherein the request from the user is a request message received from a mobile communications device.

5. The method of claim 4, wherein the digital content is stored in one or more digital content storage devices.

6. The method of claim 4, wherein in the stored digital content comprises e-mail messages of the user contained in one or more e-mail accounts.

7. The method of claim 4, wherein the stored digital content is digital content selected from the group consisting of e-mail messages, news feeds, blogs, audio content, video content, and combinations thereof.

8. A system comprising:
one or more digital content storage devices storing digital content;
one or more communication devices capable of receiving and presenting digital content; and
a digital content communication device coupling at least one of the digital content storage devices to at least one of the communication devices, the digital content communication device having an anti-abuse application that receives a request from a user to communicate digital content, accesses the digital content, performs anti-abuse analysis of the digital content, and communicates a portion of the digital content, based upon the anti-abuse analysis, in accordance with the request.

9. The system of claim 8 wherein the anti-abuse analysis determines if the digital constitutes spam.

10. The system of claim 8 wherein the anti-abuse analysis determines if the digital contains a virus.

11. The system of claim 8, wherein the one or more communications devices are mobile communications device and the request from the user is a request message received from a mobile communications device.

12. The method of claim 8, wherein the digital content is stored in the one or more digital content storage devices.

13. The system of claim 12, wherein in the stored digital content comprises e-mail messages of the user contained in one or more e-mail accounts.

14. The system of claim 12, wherein the stored digital content is digital content selected from the group consisting of e-mail messages, news feeds, blogs, audio content, video content, and combinations thereof.

15. The system of claim 8 wherein the one or more digital content storage devices are coupled to the digital content communication device through a communications network selected from the group consisting of the Internet, a wide area network, a local area network, an intranet, and combinations thereof.

16. A machine-readable medium that provides executable instructions, which when executed by a processor, cause the processor to perform a method, the method comprising:
receiving a request from a user to communicate digital content;
accessing the digital content;
performing anti-abuse analysis of the digital content; and
communicating a portion of the digital content, based upon the anti-abuse analysis, in accordance with the request.

17. The machine-readable medium of claim 16 wherein the anti-abuse analysis determines if the digital constitutes spam.

18. The machine-readable medium of claim 16 wherein the anti-abuse analysis determines if the digital contains a virus.

19. The machine-readable medium of claim 16, wherein the request from the user is a request message received from a mobile communications device.

20. The machine-readable medium of claim 19, wherein the digital content is stored in one or more digital content storage devices.

21. The machine-readable medium of claim 19, wherein in the stored digital content comprises e-mail messages of the user contained in one or more e-mail accounts.

22. The machine-readable medium of claim 19, wherein the stored digital content is digital content selected from the group consisting of e-mail messages, news feeds, blogs, audio content, video content, and combinations thereof.
